(19) United States
(12) Patent Application Publication
(10) Pub. No.: US 2008/0238878 A1
(43) Pub. Date: Oct. 2, 2008

(54) POINTING DEVICE USING FINGERPRINT

(76) Inventor: Pi-Hui WANG, Hsinchu City (TW)

Correspondence Address: LEONG C LEI, PMB # 1008, 1867 YGNACIO VALLEY ROAD, WALNUT CREEK, CA, 94598, US

(21) Appl. No.: 11/693,744

(22) Filed: Mar. 30, 2007

(51) Int. Cl. G06F 3/041

(52) U.S. Cl. 345/173

(57) ABSTRACT

The pointing device mainly contains a fingerprint sensor capable of capturing continuous images of the fingerprint of a user's finger when the finger is moved across a sensing area of the fingerprint sensor. From these continuous images, the pointing device is able to calculate the direction and speed of the movement of the finger. These pieces of information are then passed to a host computer system, which in turn adjusts the position of a cursor shown on a display device.

### TECHNICAL FIELD OF THE INVENTION

The present invention generally relates to pointing devices, and more particularly to a pointing device utilizing a user's fingerprint.

### DESCRIPTION OF THE PRIOR ART

Nowadays almost every desktop or notebook computer has at least a pointing device such as a mouse, a trackball, a stylus, or a touch panel, as one of the computer's input devices. The pointing device is electrically connected to the computer and the movement of the pointing device instructs the computer to adjust the position of a cursor shown on a display device (such as a CRT or LCD monitor). The pointing device also contains one or more control buttons whose trigger activates the computer to execute certain function or task in accordance with the position of the cursor on the display device.

The techniques of these pointing devices are widely known. However, their operation by the user usually requires a flat surface or some space for maneuvering, in addition to their extra cost of ownership. Further more, when the pointing device is integrated with the computer as in a notebook computer, the pointing device usually takes up a sizable area of the computer which is against the continuous trend for smaller form factor.

### SUMMARY OF THE INVENTION

A novel pointing device utilizing a user's fingerprint is provided herein.

The pointing device mainly contains a fingerprint sensor elastically held by a supporting member so that the fingerprint sensor is exposed from the surface of a casing. The pointing device further contains a switch member positioned under the fingerprint sensor inside the casing.

The fingerprint sensor is capable of capturing continuous images of the fingerprint of a user's finger when the finger is moved across a sensing area of the fingerprint sensor. From these continuous images, the pointing device is able to calculate the direction and speed of the movement of the finger. These pieces of information are then passed to a host computer system, which in turn adjusts the position of a cursor shown on a display device accordingly.

The fingerprint sensor can be depressed and then restored to its default position by the supporting member. The switch member is triggered every time the fingerprint sensor is depressed and released, respectively.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional diagram showing the components of an application environment of the present invention.

FIG. 2 is a schematic diagram showing the components of another application environment of the present invention.

FIG. 3 is a schematic sectional diagram showing the components of an embodiment of the pointing device when the fingerprint sensor is not pressed.

FIG. 4 is a schematic sectional diagram showing the pointing device of FIG. 3 when the fingerprint sensor is pressed.

FIG. 5 is an application scenario of the pointing device of the present invention.

FIG. 6 is a schematic diagram showing the application environment of FIG. 1.

FIG. 7 is a schematic sectional diagram showing the components of another embodiment of the pointing device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

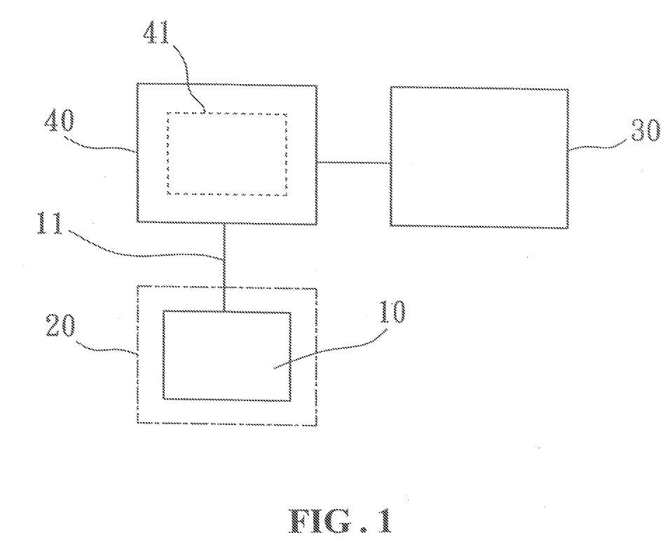

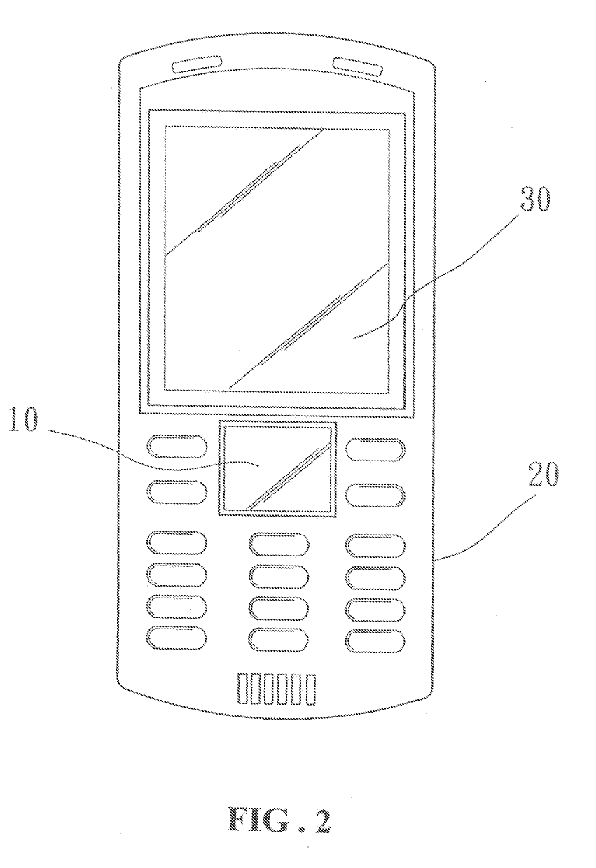

FIG. 1 is a functional diagram showing the components of an application environment of the present invention. As illustrated, the pointing device is basically a fingerprint sensor 10 provided on the surface of a casing 20 and electrically connected to a host computer system 40 via a link 11. The host computer system 40 provides output on an external display device 30 and contains a built-in fingerprint authentication module 41. As shown in FIG. 2, which is schematic diagram showing the components of another application environment of the present invention, the pointing device and the display device 30 can also be integrated into the casing 20 as a single physical object (such as a mobile handset). The casing 20 could have various shapes or forms and is not limited to what are shown in the drawings.

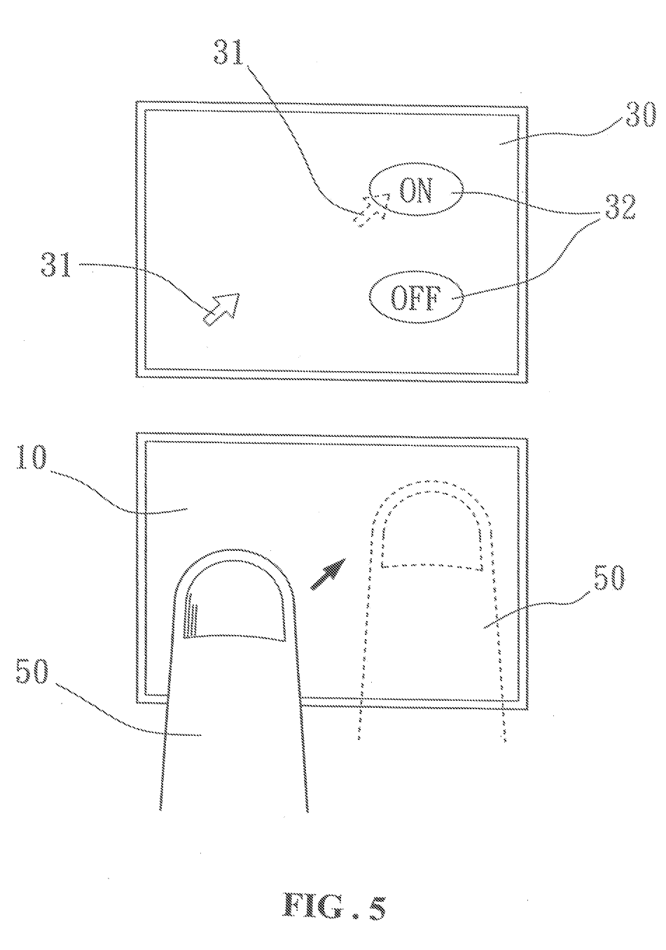

As shown in FIG. 5, the fingerprint sensor 10 of the pointing device is capable of capturing continuous images of the fingerprint of a user's finger 50 by optical means (such as CCD or CMOS camera) or by capacitance means when the finger is moved across a sensing area (not numbered) of the fingerprint sensor 10. From these continuous images, the pointing device is able to calculate the direction and speed of the movement of the finger. These pieces of information are then passed to the host computer system 40, which in turn adjusts the position of a cursor 31 accordingly, such as over to some control buttons 32 shown on the display device 30.

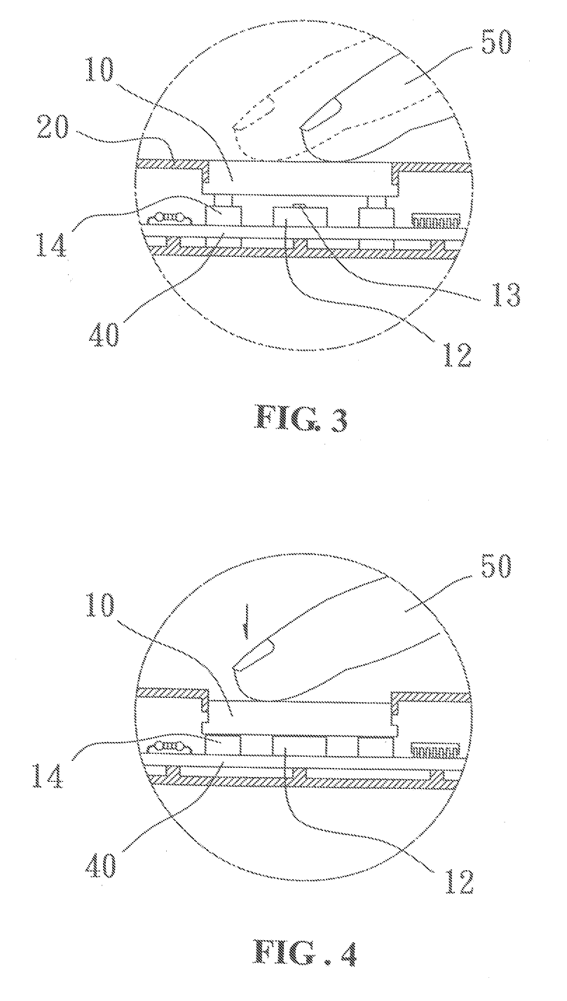

As shown in FIGS. 3 and 4, the fingerprint sensor 10 is elastically held by a supporting member 14 so that the fingerprint sensor 10 is exposed from the casing 20. In addition, the fingerprint sensor 10 can thereby be depressed by the finger 50 and then restored to its default position by the supporting member 14 after the pressure of the finger 50 is removed. Further more, a switch member 12 is positioned beneath the fingerprint sensor 10, which is triggered every time the fingerprint sensor 10 is depressed and released, respectively. Such a “click” on the fingerprint sensor 10 causes the switch member 12 to issue an “Enter” signal to the host computer system 40. When the cursor 31 is over a button 32 on the display device 30 and such a “click” occurs, the host computer system 40 decides that the user has issued the “Enter” signal to activate the function associated with the positions of the cursor 31 within the region defined by the button 32.

As mentioned earlier, the host computer system 40 may contain a fingerprint authentication module 41 capable of comparing a captured fingerprint image by the fingerprint sensor 10 against a pre-installed image in order to authenticate the user as an authorized user to the host computer system 40.

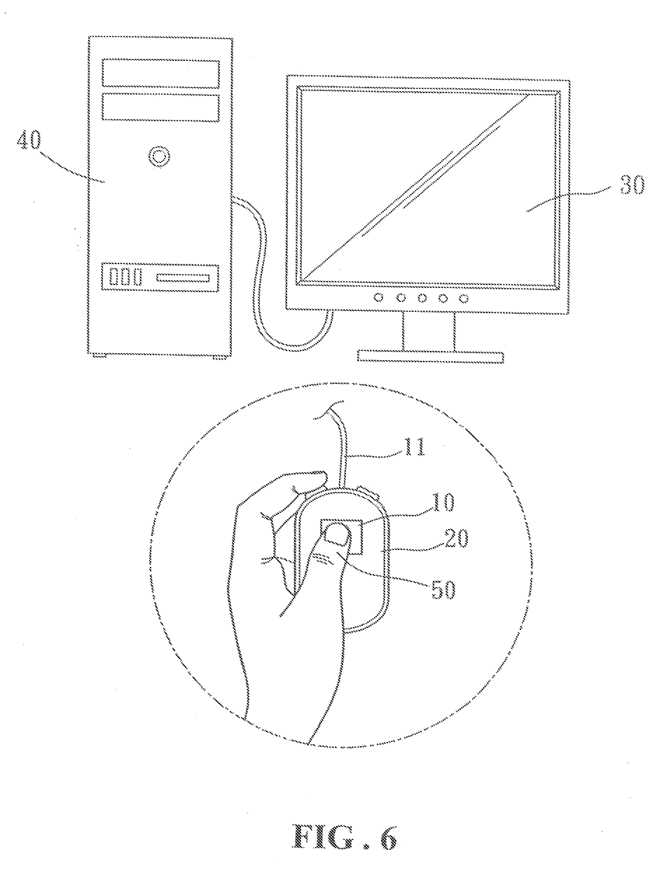

FIG. 6 is a schematic diagram showing the application environment of FIG. 1. As illustrated, the host computer system 40, the display device 30, and the pointing device are implemented as separate objects. The link 11 between the pointing device and the host computer system 40 is an appropriate signal cable therebetween.

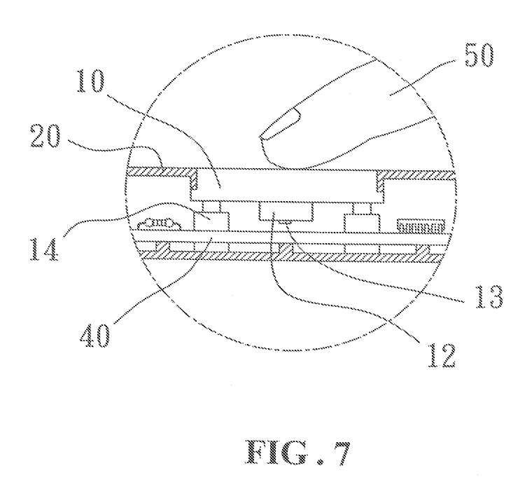

FIG. 7 is a schematic sectional diagram showing the components of another embodiment of the pointing device. In contrast to FIGS. 3 and 4, where the switch member 12 is positioned on a surface beneath the fingerprint sensor 10 with a switch button 13 pointing towards the fingerprint sensor 10, the present embodiment has the bottom of the switch member 12 attached to the bottom of the fingerprint sensor 10 with the switch button 13 pointing away from the fingerprint sensor 10.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pointing device for a computer system, comprising:
a casing;
a fingerprint sensor having a sensing area exposed from said casing, said fingerprint sensor capable of capturing continuous images of a user's fingerprint as a finger of the user is moved across said sensing area;
a supporting member inside said casing elastically holding said fingerprint sensor so that said fingerprint sensor is capable of being depressed by said finger and restored to a default position by said supporting member after the pressure of said finger is removed; and
a switch member inside said casing positioned under said fingerprint sensor, said switch member being triggered when said fingerprint sensor is depressed and released, respectively; wherein, from said continuous images, the information about the movement of the finger is calculated and passed to said computer system and the position of a cursor shown on a display device of said computer system is adjusted accordingly; and, when said switch member is triggered, a corresponding signal is passed to said computer system to activate a function associated with the position of said cursor on said display device.

2. The pointing device according to claim 1, wherein said computer system has a fingerprint authentication module capable of comparing a captured fingerprint image by said fingerprint sensor against a pre-installed image so as to authenticate said user as an authorized user to said computer system.

3. The pointing device according to claim 1, wherein said continuous images captured by said fingerprint sensor is achieved by one of an optical means and a capacitance means.
